(19) United States
(12) Patent Application Publication
(10) Pub. No.: US 2002/0191536 A1
(43) Pub. Date: Dec. 19, 2002

(54) Algorithmic method and computer system for synthesizing self-healing networks, bus structures, and connectivities

(76) Inventors: Laurence Edward LaForge, Reno, NV (US); Kirk Fredrick Korver, Salt Lake City, UT (US)

Correspondence Address: NATH & ASSOCIATES PLLC, 1030 15th Street, NW - 6th Floor, Washington, DC, 20005, US

(21) Appl. No.: 10/050,068

(22) Filed: Jan. 17, 2002

Related U.S. Application Data
(60) Provisional application No. 60/261,863, filed on Jan. 17, 2001.

(51) Int. Cl. H04J 1/16

(52) U.S. Cl. 370/216; 370/214

(57) ABSTRACT

The invention is an algorithmic method, or a computer implementation thereof, which synthesizes connectivities. In its prototypical form, the invention computes pairwise channels for an arbitrary number of nodes, minimizing both latency and the cost of channels, such that all, or nearly all, healthy nodes remain connected, despite a prescribed number or proportion of failures in channels and/or nodes. The invention also solves a similar problem, where minimum latency is replaced or augmented by maximum throughput. In general, channels may bear a non-uniform cost, nodes are assigned a value, each channel or node has a corresponding latency and capacity, and fault patterns may be probabilistic or deterministic. In particular, the invention optimizes the connectivity of large numbers of computers, perhaps dynamically self-organizing. Beneficial applications include the design and operation of self-healing, fault tolerant multicomputers and wired networks, as well as wireless networks having little or no dependence on central antennae.

### BACKGROUND OF THE INVENTION

The invention relates to the formation of networks or bus structures that connect nodes, most generally in the domain of parallel processing, and with applications to the emerging field of pervasive computing [Buderi 2001]. The invention is especially applicable to automated design of fault tolerant, minimum cost connectivities with minimum latency and/or maximum throughput. For healthy nodes to effectively cooperate, a substantial number of them, perhaps all, must be capable of communicating as a quorum [Moore and Shannon 1956]. In addition to benefiting the designer of networks or bus structures, the invention can be embedded—as hardware, software, or a combination of both—into individual nodes, especially those endowed with capabilities for wireless communication. For the latter, in particular, the invention enables dynamic, self-healing connectivities from which healthy nodes organize themselves as quorums, in the process excising faulty nodes. Similarly, the invention can be operationally embedded in one or more controllers that issue instructions to nodes for forming a quorum. In each case, the invention optimizes connectivities with respect to desired characteristics: maximum fault tolerance, minimum latency, maximum throughput, and minimum cost or maximum net value.

The point-to-point channel is an empowering foundation of communications systems, and will remain so for quite some time [Buderi 2001]. Whether the channel is wired or wireless, all communication systems are channel limited. Some channels may be more expensive than others. For example, some channels may have to be realized by laying cable, while others might be established over leased lines. Accordingly, the invention admits non-uniform channel costs, and properly gauges the expense of quorum connectivity by the sum of the cost of all channels. When the channel costs are all identical then this figure of merit in effect reduces to the channel count.

Similarly, some nodes may be more valuable than others For example, nodes at locations where people are deployed may be more valuable than nodes at unmanned locations. Accordingly, the invention admits non-uniform node values, and properly gauges the gross value of quorum connectivity by the sum of the value of all nodes it contains. When the node values are all identical then this figure of merit in effect reduces to the number of nodes in the quorum.

The net value of a quorum equals its gross value minus the expense of channels needed to assure, in a worst-case or probabilistic sense, that such a quorum can be formed in the presence of faulty nodes or channels. Herein lies a foundation of the invention's novelty: designers of networks or bus structures should seek connectivities, be they quasi-static (as with wired networks) or dynamic (as with wireless networks of mobile nodes), which maximize net quorum value. Where nodes have identical values, and channels have the same cost, the maximization problem reduces to the following prototypical form:

Synthesize the connectivity among n-nodes, tolerant to ƒ failures, and using the fewest channels (1)

To understand the graph-theoretic basis for the invention, illustratively, though not exhaustively, consider (1) for connectivities among n nodes, tolerant to as many as ƒ faults in nodes, distributed in a worst-case fashion, such that a failed node is not only incapable of computing, but communications may pass neither from nor through the node. The vertices of the graph correspond to nodes, the edges of the graph correspond to channels, and the connectivity of the graph equals ƒ+1. ¹ To solve (1), therefore, an algorithmic method, or computer implementation thereof, need respond with a representation of an (ƒ+1)-connected graph whose order equals n and whose size is minimized at:¹

┌n(ƒ+1)/2 ┐ (2)

¹See [LaForge et al 2001] or [Bollobás 1998] for terminology and definitions related to graph theory.

Formula (2) is the Harary-Hayes Bound, derived first in [Harary 1962] and, later, in an apparently independent effort, by [Hayes 1976]. While the former adopts a largely graph-theoretic viewpoint, the latter is notable for its application to problems solved by the invention. In particular, an algorithmic method or computer implementation, with knowledge of the results of Harary and Hayes, can synthesize chordal graphs which are regular, or nearly so. These graphs comprise exact solutions to (1), for any n and ƒ.

Though illustrative, the preceding nevertheless falls short of solving an essential design problem under consideration. To wit: we must further factor in requirements for performance, paramount among which is minimum latency. In the case of packet-switched networks, for example, industry standards for voice over Internet Protocol (VOIP) prescribe a source-to-destination latency of no more than 40 milliseconds. With the contemporary state-of-the-art, the dominant source of delay lies not in the channel per se, but rather in routers and servers corresponding to nodes in the connectivity to be synthesized.

Continuing the example, assume that the sustained traffic through each node is maintained below 78% utilization. In this case contemporary realizations impart approximately 9 milliseconds delay per node, or hop, traversed. To clarify: the number of hops between nodes equals one less than the edge distance between the corresponding vertices in the underlying graph.¹ To be conservative, therefore, a contemporary VOIP message should traverse four or fewer hops. If we want to ensure that every pair of healthy nodes is VOIP-capable then, in the language of graph theory, the diameter of any subgraph induced by deleting up to ƒ vertices should be no greater than five.¹ Such an induced subgraph is, in the language of fault tolerance, a quorum. Alternatively, suppose that we impose the somewhat looser requirement that some healthy node be capable of VOIP with every other healthy node. In this latter case we seek to limit to at most five the radius¹ of any subgraph induced by deleting up to ƒ vertices. In the illustrative context of packet networks, therefore, radius and diameter are primary measures of latency.¹ Combining terminologies, we may succinctly recast (1) as

Synthesize an (ƒ+1)-connected graph of order n and minimum size ┌n(ƒ+1)/2┐ which minimizes the maximum quorum redius or diameter. (3)

¹See [LaForge et al 2001] or [Bollobás 1998] for terminology and definitions related to graph theory.

The preceding example concerning VOIP pertains largely, though not exclusively, to channels realized by wires. The invention benefits wireless networks as well. Even the illustrative unweighted formulation (3), when solved by the invention, bears significant import on optimum wireless connectivities, with the potential for greatly reducing, perhaps eliminating, dependency on central antennae. For example, contemporary investigators of autonomous miniaturized rovers, called motes, articulate a compelling need for the invention, when used to achieve dynamic, self-healing connectivities from which healthy nodes organize themselves as quorums:

Forming ad hoc multihop networks is the most exciting application of mote-to-mote communications. Multihop networks present significant challenges to current network algorithms —routing software must not only optimize each packet's latency but also consider both the transmitter's and the receiver's energy reserves . . . a highly dynamic network topology and large packet latency result [Warneke et al 2001].

Similarly, and as illustrated by FIGS. 1, 3, and 4 of [LaForge et al 2001], the invention enables fault tolerant multicomputers at minimum cost. Herein a uniform-cost/uniform-value model may well apply. In any case, the invention minimizes interprocessor latency, whether the channels are wired (e.g., copper or fiber optic) or wireless (e.g., radio or laser).

To recap: the invention is beneficial to the design or operation of self-healing, fault tolerant multicomputers and wired networks, as well as wireless networks having little or no dependence on central antennae. With these illustrations of how the invention is useful, let us further unfold how the invention is both novel and not obvious to those with ordinary skill in the quantitative art of connectivity.

In the 1950's, Edward Moore derived a lower bound on the radius of any graph with prescribed order, and whose vertices have bounded degree.¹ Until 2000, however, it appears to have been unknown whether it was possible to algorithmically attain Moore's natural limit on tightness, fault-tolerant formulation for which is derived by [LaForge et al 2001]:

log_{ƒ}[(n(ƒ−1)+3)/(ƒ+2)]=ρ_{Moore}⁻ (4)

¹See [LaForge et al 2001] or [Bollobás 1998] for terminology and definitions related to graph theory.

Previously, the bulk of mathematical interest focused on questions such as, “For what n and ƒ do there exist n-vertex (ƒ+1)-regular graphs which perfectly match the Moore Bound?” ([Alphonso 2000], Sec. 2). Though such questions are academically interesting, the attendant answers (many of which remain unknown) would not be of immediate benefit to designers of networks and bus structures, nor to programmers of software that aids such designers, nor to the self-healing operation of multicomputers and networks heretofore described. This is largely because, even in the absence of faults, the exact Moore Bound (3) is often impossible to attain [Hoffman and Singleton 1960]. On the other hand, and as explained herein, algorithmic solutions to (3) are of immediate value. With limited exceptions (e.g., [Murty and Vijayan 1964], [Bollobás 1978] IV.2-3), moreover, few investigators considered the even more formidable issue of achieving ┌ρ⁻_{Moore}┐ in the presence of faults. Absent mathematical foundation, that is, the present invention was therefore not readily foreseeable. This changed when [LaForge 2000] characterized Hamming graphs, fountainhead for novel connectivities which minimize channel count (2), and whose worst-case tolerance ƒ is superlogarithmic, but sublinear, in n. The attendant quorums exhibit optimal latency: their diameter converges to the Moore Bound on radius, even as the number of faults attains the rated maximum ƒ. As the only complete Hamming graphs, moreover, clique-based cubes are preferable to traditional (but suboptimal) cycle-based cubes, whose radii diverge from ┌ρ⁻_{Moore}┐ [LaForge et al 2001].

The invention is advantageous largely because theorems, such as those for clique-based cubes, can be unwieldy to apply. Proper application of such theorems requires extensive expertise, and the process is well suited to the novel algorithmic method and software comprising the invention.

Beyond a worst-case model of faulty nodes, formulation (3) can be extended to important, novel variations: a) Randomly distributed faults. b) Fault tolerance that scales in proportion to n. c) The underlying graph is allowed to be irregular. d) Faulty channels instead of, or in addition to, faulty nodes. e) Quorums require connectivity of almost all (as opposed to all) healthy nodes.

With respect to the generalized formulation introduced at the beginning of this section, (a) through (e) can be further varied, singularly or in combination, as follows. f) Non-uniform channel cost, including, but not limited to, dollar prices that increase with distance; in addition, feasibility costs, perhaps infinite, which are a consequence of transmission power and antenna gain. g) Non-uniform latency in channels and/or nodes. h) Non-uniform values for nodes. i) Maximum throughput, in place of, or in addition to, minimum radius or diameter. Particular conditions on throughput would include, but not be limited to, expected or worst case values overall. j) Channel redundancy in concert with self-healing configuration by mutual test and diagnosis (MTAD), a special case of which is to excise infiltrators [LaForge and Korver 2000 MTAD].

With respect to (j) in particular, a potent application of the invention exploits the fact that the minimum connectivity to achieve a tight quorum (3) is frequently the same, or nearly the same, as that needed for a quorum to diagnose and heal itself [LaForge and Korver 2000 MTAD].

Still further extensions of the invention are beneficial and novel. For example, k) to generalize from symmetric channels to asymmetric channels, the invention would embody algorithmic methods pertaining to directed graphs. This model would, in fact synergistically complement MTAD [LaForge 1994], [LaForge et al 1994]. In addition, 1) the incorporation of multigraph models into the invention would explicate the case of multiple paths between nodes.¹ Moreover, m) by presenting hypergraph¹ models as part of its feature set, the invention would predictively accommodate the scenario where all or part of the synthesized connectivity corresponds to a multidrop network [Ramtcke 1994]. ¹See [LaForge et al 2001] or [Bollobás 1998] for terminology and definitions related to graph theory.

A principal contributor to the novel nature of the invention is its ability to synthesize connectivities based on rigorous, analytic results. This is to be distinguished from a preponderance of simulation-based methods and software for computer aided design, the predictive power of which is intrinsically weaker than that of the invention. By virtue of their reliance on simulation as a first line of quantitative expression, inventions such as Berman ('831) promote design by trial and error.

As a rule, such methods proceed without cognizance of how close a design iteration comes to optimal. The present invention, by contrast, carries out synthesis and analysis of connectivities, in the process drawing on rigorous analytic results from quantitative disciplines comprising the science of connectivity.

### BRIEF SUMMARY OF THE INVENTION

In its basic embodiment, the invention consists of an algorithmic method manifested as a computer aided design (CAD) program, preferably one that features a graphical user interface (GUI). To command the invention to solve prototypical optimization problem (1) or (3), for example, the user inputs n, the number of nodes, as well as ƒ the number of faults to be tolerated. Selecting from its knowledge base of theorems, the invention responds by synthesizing a netlist that prescribes pairs of nodes to be connected via channels. The invention graphically displays this netlist, along with architectural properties, such as the maximum quorum radius or diameter, the total number of channels, and the maximum throughput.

More generally, and again in the domain of connectivity design, the invention solves variants (a) through (m) of (1) or (3), in a fashion analogous to that described in the preceding paragraph. For example, if the channel cost is non-uniform (f), then the invention prompts the user to enter the respective costs, records and displays these values, and synthesizes the corresponding optimal connectivity.

For in situ operation of self-healing multicomputers or networks, the invention typically manifests as a standalone task, program, dynamically linked library module, or similar software-based component. The invention presents an application program interface (API) to other system components, with behavior largely analogous to the case where the invention is employed as a CAD tool.

For the dynamic case, the invention starts with the connectivity of the current quorum. A new node comes into contact with a subset of the current quorum. The quorum responds by computing, in a distributed parallel fashion, an adjusted connectivity that assimilates the new node, if deemed friend. If the current quorum deems the new node to be a foe then the current quorum will act to repel or suppress the intruder. A node exiting a quorum is algorithmically similar to a node failing. The quorum can either continue without reconfiguring itself, or, during idle periods, restart as in the quasi-static case. FIGS. 29, 30, 33, 34, and 35 of [LaForge 1999] illustrate the action of distributed diagnosis and quorum configuration in the simplest cases:ƒ=1 or ƒ=2.

### BRIEF DESCRIPTION OF THE DRAWINGS

FIG. 1 depicts the invention as used to design self-healing connectivity, for prototypical cases (1) or (3).

1) The user specifies the number of nodes, as well as the maximum number of faulty nodes.

2) The invention proffers choices to the user.

3) The user selects a connectivity.

4) The invention synthesizes the connectivity.

5) A and B. The user analyzes an instance of the connectivity by injecting faults. The fault pattern may be generated by the invention, or the user may craft the fault pattern by hand.

6) A and B. The user can review the throughput of the faulted instance, using metrics such as parallel dataflow.

7) The user can check the latency of the faulted instance, using metrics such as radius and diameter.

FIG. 2 displays the results of applying the invention to design of a sample traffic set for GovNet, a fiber optic intranet [GSA 2001 GovNet RFI].

A) Physical assignment of K₁₁(88), a 1-dimensional 11-ary K-cube-connected cycle, synthesized by the invention for the sample GovNet traffic set. Zoom view of Little Rock, Memphis, Nashville, and Birmingham. The overall result connects 88 buildings, is worst-case tolerant to up to 11 faults, and has latency less than 40 milliseconds, compatible with standards for VOIP.

B) Connectivity of K₁₁(88), synthesized by the invention. The lack of perceptible features reinforces the intricacy of devising connectivity that minimizes channel count, maximizes fault tolerance, and minimizes latency. Optimizing an 88-node network exceeds the pencil-and-paper power of even experienced designers.

FIG. 3 comprises three tables:

A) Table showing how the worst-case fault tolerance varies with channel count. I.e., formula (2) applied to an 88-node GovNet.

B) Table contrasting cost: probabilistic regular versus worst-case fault tolerance, channel count for GovNet traffic set, n=88. Probabilistic case illustrated for 20=ω(n) (defined in DETAILED DESCRIPTION). This corresponds to a quorum confidence of 95%, for which the invention would synthesize Θ(log n) local sparing of a Θ(n/log n) cycle [LaForge 1999 Trans Comp].

C) Table contrasting channel count cost of probabilistic connectivity: regular versus irregular, GovNet traffic set. Regular connectivity from Table B of FIG. 3. For the irregular architecture, the invention would synthesize an ω(n) by n−ω(n) complete bipartite graph. Here n=88 and ω(n)=2, yielding quorum confidence >99%. For the worst case, however, note that the irregular connectivity can only tolerate one fault.

FIG. 4. A single table illustrating the particular solutions synthesized by the invention, when applied to the design of a VOIP-capable GovNet, based on a sample traffic set for 88 nodes. The table also illustrates how latency tends to decrease synergistically with increasing fault tolerance.

FIG. 5 illustrates the invention manifested for self-healing operation of two wireless applications.

A) High performance multicomputers, with channels implemented as free-space optical interconnect, such as that afforded by vertical cavity semiconductor emitting lasers (VCSELs)

B) Dynamic, wireless networks of reconnaissance satellites and roving nanoprobes. Upper right: 2D ternary K-cube-connected edge, with limit law for quorums converging to the Moore Bound.

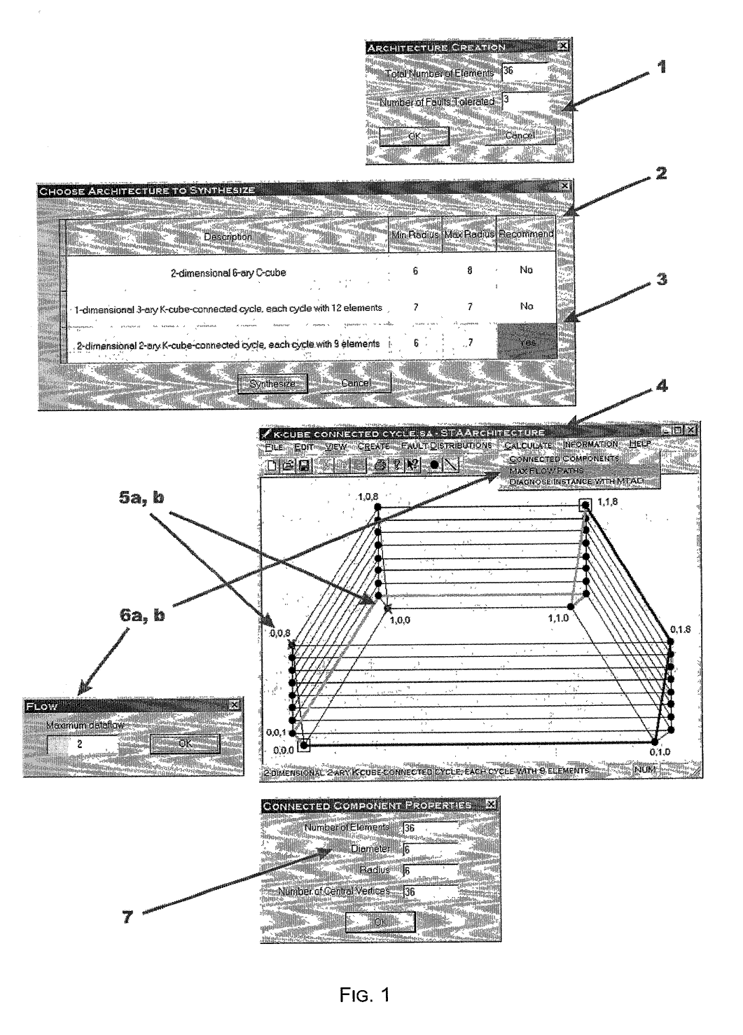

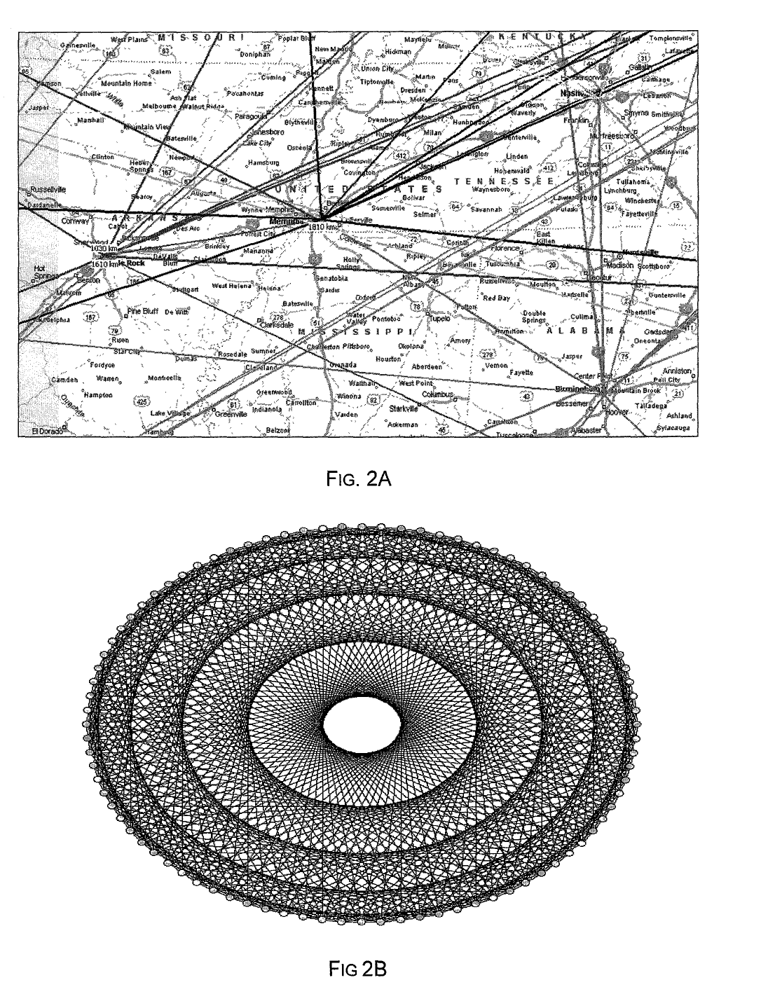

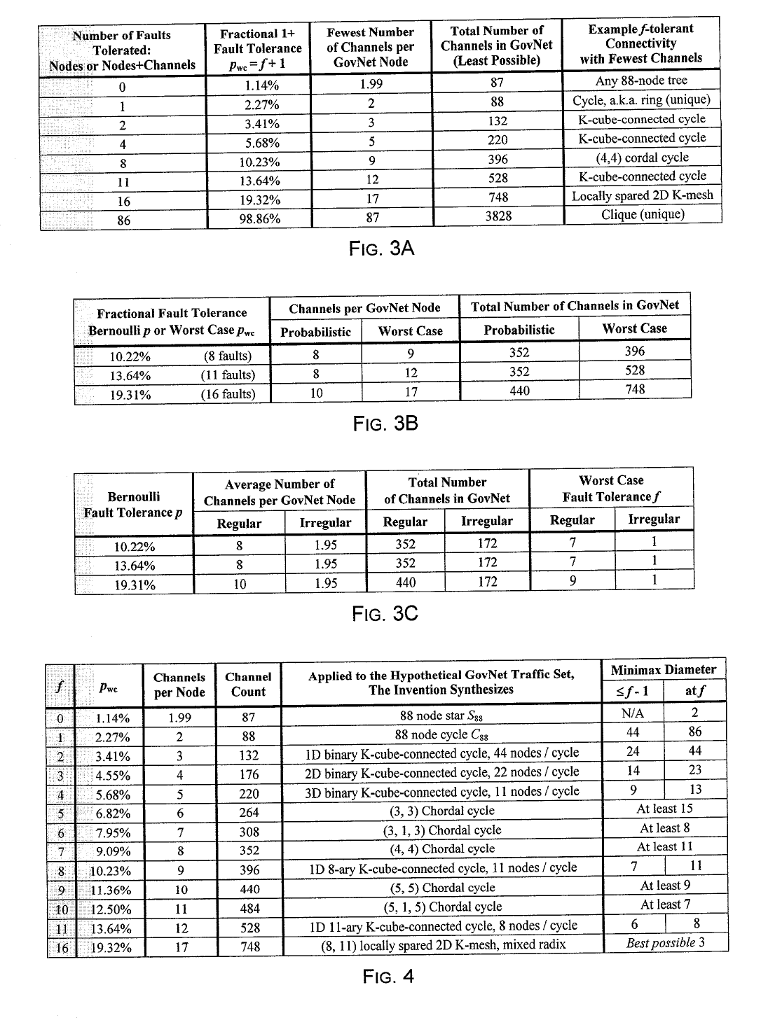

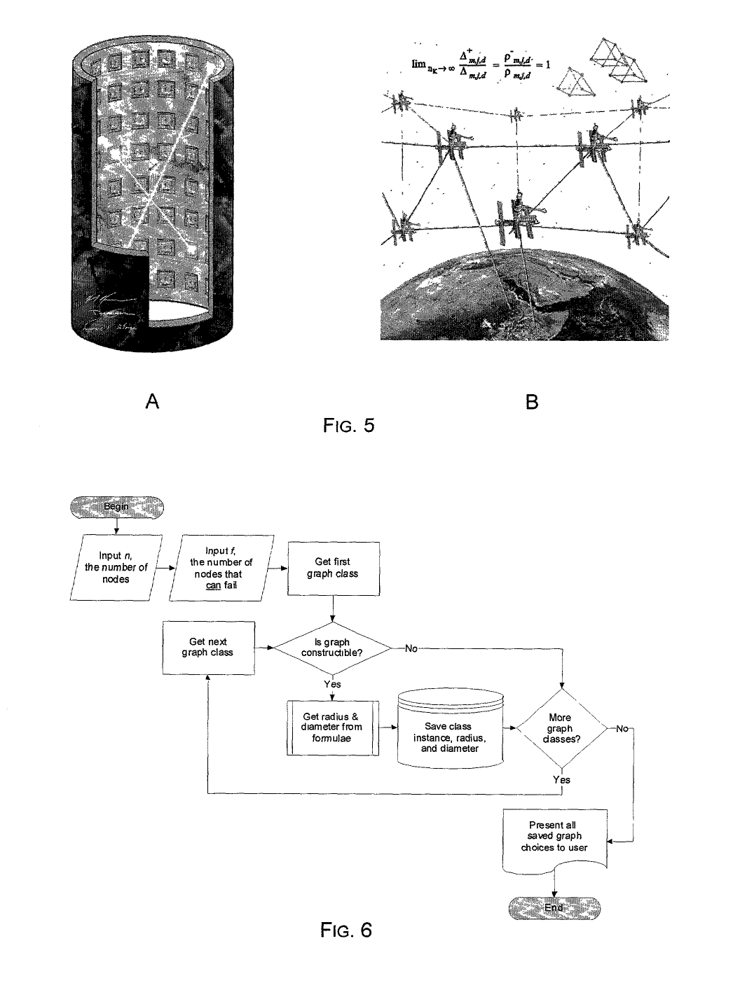

FIG. 6 is a flowchart for the algorithmic method, comprising the computation between steps 1 and 2, as indexed under FIG. 1.

### DETAILED DESCRIPTION OF THE INVENTION

FIG. 1 depicts the invention in a preferred, basic embodiment; i.e., a computer aided design (CAD) program for solving a prototypical formulation, such as (1) or (3). A user inputs n, the number of nodes, as well as ƒ the number of faults to be tolerated. The invention proceeds with synthesis and analysis, as described under indicia 1 through 7 of FIG. 1.

As detailed by the flowchart of FIG. 6, the invention selects candidates from parameterized classes of connectivities, matching constructibility to the objective function and constraints. The invention effects this process by examining its knowledge base of theorems.

Each class of connectivities represents a family of multivariate curves, and is characterized by a class of theorems. A given family may not necessarily contain constructible connectivity for all combinations of n and ƒ, and the invention first tests against this criterion. However, and as delineated in the BACKGROUND section herein, there is always a chordal graph which generates a connectivity with minimum channel count and prescribed fault tolerance. Therefore, the basic embodiment of the invention always provides an optimum solution to (1). The table of FIG. 3A illustrates the exact cost of this optimum, expressed as channel count, for n=88, and for selected values of ƒ ranging from 0 to 86.

Secondarily, and again as indicated in FIG. 6, a candidate connectivity, even if constructible, may not reside on a portion of the scaling curve which satisfies constraints for latency (3). For example, and as delineated in the BACKGROUND section herein, variations on the complete Hamming graphs exhibit worst-case fault tolerance ƒ that is superlogarithmic, but sublinear, in the number of nodes n. For faults numbering up to ƒ one less than the connectivity, the maximum quorum diameter is at most one greater than the dimension of the underlying K-cube, with such knowledge drawn from the theorems of [LaForge at al 2001]. Furthermore, while the diameter of quorums induced from K-cubes and their relatives converge to the Moore Bound on radius, the particular n and ƒ supplied may determine a portion of the multivariate curve for K-cubes whose minimax quorum radius or diameter is numerically greater than that from an alternate family. Even in its basic form, that is, the invention embodies design diversity.

The behavior and implementation of such design diversity is perhaps best illustrated with a specific example. E.g., let us design minimum connectivity that makes a sample 88-node GovNet traffic set tolerate ƒ faults, in the worst case [GSA 2001 GovNet RFI], with the resulting quorum VOIP-capable.

At ƒ=0, the invention synthesizes a star S₈₈ with 87 leaves. S₈₈ is, in fact, the unique zero-tolerant connectivity with minimum channel count, minimum radius 1, and minimum diameter 2 ([LaForge 1999] Thm 3). Recalling the discussion in the BACKGROUND section herein, S₈₈ has a radius and diameter no greater than 5, and thus satisfies requirements for VOIP. However, if the central node of S₈₈ fails then no quorum is possible. As prudent designers, we therefore strive for an 88-node GovNet that tolerates at least one fault.

At ƒ=1 the invention synthesizes a cycle C₈₈: the unique one-tolerant connectivity with minimum channel count, minimax radius 44, and minimax diameter 86 ([LaForge 1999] Thm 4). The term “minimax ” derives from (3), wherein we seek to minimize the maximum radius or diameter of quorums induced by deleting up to ƒ nodes.

To explicate: at zero faults the radius and diameter of C₈₈ are both equal to 44. With one fault we obtain a quorum by deleting any node from C₈₈. The radius shrinks to 43, while the diameter grows to 86. The minimax diameter of C₈₈ does not satisfy latency requirements for VOIP, so minimum channel count connectivity is not feasible at ƒ=1. However, this does not mean that we must revert to the star S₈₈ . By the Harary-Hayes Bound (2), that is, the degree of each node increases by one as we increment the fault tolerance. This adds more channels to the connectivity. With more channels, we should be able to, and in fact can, tighten the network. As the table of FIG. 4 reveals, the same connections that maintain fault-tolerant connectivity at minimum cost can reduce latency —if, that is, the proper connectivity is synthesized. The invention synthesizes such connectivity properly.

Continuing with the sample GovNet design, at ƒ=2 the problem space becomes sufficiently complicated to warrant computer automation of the algorithmic method. The invention synthesizes a one-dimensional binary K-cube-connected cycle, with each cycle containing 44 nodes. At zero faults the diameter equals 23. At one fault the quorum diameter is at most 24. At two faults the quorum diameter jumps to 44. The minimax diameter of 44 does not satisfy latency requirements for VOIP, so, at ƒ=2, we do not have a feasible design.

We continue our design iteration, with results as recorded in the table of FIG. 4, until the invention proffers a tight connectivity that fits the latency envelope for VOIP. We enter this envelope at ƒ=11, or a fractional fault tolerance of about 13%. The invention synthesizes a one-dimensional 11-ary K-cube-connected cycle K₁₁(88), depicted in FIG. 2B. Detailed calculations by the invention reveal that the quorum radius starts at 5 and may drop a bit, from 5 to 4, when the network sustains 10 failures. When the number of faults does not exceed the rated fault tolerance of 11, moreover, the quorum radius never exceeds 5. Therefore, there is always a healthy central node (actually, several of them) which can communicate with all other healthy nodes, and with accepted latencies for VOIP. The last two columns of in the table of FIG. 4 summarize the invention's knowledge about the diameter of quorums of K₁₁(88): at zero faults, the diameter and the radius both equal five. From 1 to 10 faults, the diameter may grow to 6. At the limit of the rated fault tolerance ƒ=11, the diameter could jump to 8. If we believe that the equipment at hand justifies stretching the latency envelope for VOIP, then we might accept K₁₁(88), with the caveat that some pairs of nodes may not be able to communicate intelligible VOIP when the number of failures reaches 11.

If, on the other hand, we are inclined to conservatively satisfy latency requirements for VOIP, albeit at greater cost, then we continue incrementing the fault tolerance. At each stage the invention synthesizes a connectivity that either matches (3), lies on a curve that asymptotically converges to (3), or, in some cases (such as the (3, 3) chordal cycle at ƒ=5) interpolates between such solutions. As the per-node channel density increases, the invention is more likely to synthesize a connectivity which exactly matches (3), and in fact this is the case in the last row of the table of FIG. 4. At ƒ=16, we obtain a locally spared, two-dimensional, mixed radix K-mesh K_{(8,11)}(88). Only recently discovered by LaForge, such connectivities are relatives of the K-cube structures reported in the published literature, such as the K₁₁(88) synthesized at ƒ=11 [LaForge and Korver 2000]. Especially noteworthy: at zero faults, K_{(8,11)}(88) starts out with the best possible radius and diameter of 3; moreover, quorums of K_{(8,11)}(88) maintain a radius and diameter of 3, right up to, and including,² the rated fault tolerance ƒ=16. The latency remains squarely within the requirements for VOIP. With such a design, and with modeling assumptions as set forth herein, GovNet users would never see long-latency degradation of audio, despite failure of more than 18% of all nodes. This latter design, wherein GovNet is endowed with relatively rich connectivity, delivers heretofore unrealized levels of fault tolerance and, simultaneously, minimum latency. The invention enables these objectives to be achieved, using the minimum number of channels that Nature will permit. ² In this case the best possible radius is 3, one greater than the integer ┌ρ⁻_{Moore} ┐. This serves as an example where the Moore Bound cannot be achieved, and in general applies for constant rational worst-case fault tolerance P_{wc}≠(j−1)/j, for integers j>2 and sufficiently large n. If P_{wc}=(j−1)/j then the best possible diameter 2 is realized by Turán's unique extremal graph that obstructs a j+1 vertex clique [Turán 1954].

To return to the point that spurred the preceding example, it will be appreciated that the invention makes nontrivial use of design diversity, even in mapping the solution space to (3), for the relatively straightforward case n=88. In the process, the invention draws on five classes of theorems corresponding to five families of connectivity. Specifically: i) trees (of which stars are a special case); ii) traditional cycle-based hypercubes (of which cycles are a special case); iii) chordal graphs (the constructions of Harary and Hayes) iv) K-cube-connected cycles (a close relative to K-cubes); and v) locally spared K-meshes. Among these, K-mesh connectivities are as yet unpublished in the literature.

This latter point bears elaboration, since it is in fact a key characteristic of the invention. Referring again to FIG. 6, the algorithmic method that selects candidates for connectivity can draw from best-of-breed results in the science of connectivity. The preceding example with GovNet makes use of knowledge about venerable constructions due to Harary and Hayes (iii), recently published results of LaForge et al. (i, ii, and iv), and fresh, undisclosed discoveries, such as LaForge's results for K-meshes (v), or new observations about Turán graphs.² ² In this case the best possible radius is 3, one greater than the integer ┌ρ⁻_{Moore} ┐. This serves as an example where the Moore Bound cannot be achieved, and in general applies for constant rational worst-case fault tolerance P_{wc}≠(j−1)/j, for integers j>2 and sufficiently large n. If P_{wc}=(j−1)/j then the best possible diameter 2 is realized by Turán's unique extremal graph that obstructs a j+1 vertex clique [Turán 1954].

Having detailed how the invention solves prototypical problems (1) or (3), let us elaborate, with judicious breadth and depth, generalizations corresponding to variants (a) through (m), as enumerated in the BACKGROUND section herein. In lieu of reciting all 8191 combinations of (a) through (m), the ensuing descriptions reinforce salient aspects of the invention, as will be apparent to those skilled in the art.

Designing against worst-case fault patterns is appropriate when defending against intelligent, directed hostilities, or against precision cyber-attacks on node software or hardware. Alternatively, we can strive for connectivity which is probabilistically self-healing. For example, suppose that nodes fail with Bernoulli probability p. Such faults could be the consequence of blanket hostilities, of software errors, of circuits wearing out, or of unpredicted power blackouts. Similar to the preceding procedure for worst-case design, we could use the invention to converge on probabilistically self-healing connectivity (i.e., variants (a) and (b)), with reduced costs as follows.

For an n-node graph architecture that is regular or nearly regular, we need pay only 2┌log_{1/p}[n·ω(n)]┐ channels per node; this assures, with probability 1−o(1), that all healthy nodes remain connected as a single quorum. Here ω(n) is an arbitrary increasing function of n, and which can be used to tune the tradeoff between cost and the probability that a quorum is achieved. Landau's notation o(1) denotes any function, such as 1/ω(n), which tends to zero with increasing n. In consequence, the minimum channel count of probabilistically fault tolerant regular connectivity scales as n·┌log_{1/p}[n·ω(n)]┐. In terms of orders of magnitude, the latter may be more succinctly expressed as Θ(n·log n), and is considerably less expensive than the quadratic channel cost Θ(n²) we pay to tolerate faults in the worst case. Furthermore, if we can allow a highly irregular connectivity, then (and perhaps counter to one's intuition) we can reduce the probabilistic channel cost to the best possible ω(n)−ω²(n)/n, where ω(n) is as above.

These probabilistic results build on the work of [Blough 1988], in the case of irregular connectivities, as well as additional, heretofore-undisclosed discoveries due to LaForge, for regular connectivities. They further illustrate the modularity of the key portion of the algorithmic method depicted by FIG. 6. With respect to variants (a) and (b), that is, the invention is cognizant of these results, and incorporates algorithms that optimize the corresponding connectivities.

Similar to the preceding model for a Bernoulli proportionp of failures, we can ask for self-healing connectivities when the minimum number of channels per node (i.e., the minimum degree in the underlying graph) scales in worst-case costant proportion P_{wc} to the number n of nodes.³ In this case we in effect combine variant (b) (but not (a)) with prototypical problem (1) or (3). Refer in particular to the second column of the table of FIG. 3A. Applying formula (2) for a constant proportion P_{wc}, that is, the number of channels equals n²·p_{wc}. For any given p_{wc}, therefore, the 88-node illustration of the table of FIG. 3A is just a point on the quadraticcurve for the channel cost of scaling. This further elucidates a key aspect of the invention previously articulated: the invention is cognizant of this quadratic curve, and synthesizes self-healing connectivities that tightly match it. ³ This is essentially the same as, but somewhat more convenient than, letting ƒ scale in proportion to n.

To amplify the preceding, compare the worst-case channel cost of self-healing connectivity with that in the probabilistic case. The table of FIG. 3B exemplifies this tradeoff. Combining variants (b) and (c), the table of FIG. 3C contrasts the cost of regular versus irregular self-healing connectivity, for the identical Bernoulli fault tolerance p.

Similar to the procedure detailed previously for worst-case design, we could use the invention to rapidly converge on probabilistically self-healing connectivity, with reduced costs as listed above. Or, we could winnow alternatives in order to quantify cost-benefit tradeoffs. With our 88-node GovNet, for example, suppose that we accept the 528 channel K₁₁(88) as our baseline connectivity, with worst-case fault tolerance and latency as set forth in the next-to-last row of the table of FIG. 4. What are the benefits of a probabilistically optimized connectivity that uses the same, or about the same, number of channels? Assuming that an irregular architecture is acceptable, we probe the invention for bipartite graphs as described in the table of FIG. 3C. Bracketing our baseline channel count of 528, the invention synthesizes connectivities whose shorthand names are K_{6,82} ,(492 channels) and K_{7,81} (567 channels).

Continuing the example, this comparison provides insight about the costs and benefits of optimum connectivities, under different models. In the worst case, the 12-fault-tolerant K₁₁(88) is preferable to either K_{6,82}(5-fault-tolerant) or K_{7,81} (6-fault-tolerant). For a matching proportion p=19.32% of faults, however, the probability that K_{7,81}contains a quorum equals 0.999989 —uncannily close to the “five nines ” advertised by many contemporary network services. Moreover, any such quorum maintains radius and diameter two—much better latency than in the case of K₁₁(88). In this case, and in general, the invention recommends optimum connectivities, thus empowering policy makers to make informed choices.

Regarding variant (d), a worst-case model that admits faults only in nodes subsumes the erstwhile richer model wherein we allow up to ƒ failures in nodes and channels. This is because, in the language of graph theory, edge connectivity is no greater than vertex connectivity.¹ An analogous conclusion does not apply, however, when faults are distributed in a probabilistic fashion. In the latter case, node failures are much more devastating than channel failures [LaForge 1999 Trans Comp]. The invention is cognizant of these trends, and synthesizes optimum connectivities accordingly. ¹See [LaForge et al 2001] or [Bollobás 1998] for terminology and definitions related to graph theory.

The invention furthermore subsumes variant (e), including, but not limited to, tandem operation with variants (a) and (j). As to the latter, FIGS. 10, 11, and 12 of [LaForge and Korver 2000 MTAD] illustrate how, with probability approaching one, a network or bus structure can correctly self-diagnose all faulty nodes, and almost all healthy nodes, using a constant number of tests per node. This result translates directly to a distributed, algorithmic method for excising faulty nodes via locally applied tests. When the underlying channels are synthesized to match pairwise test, the attendant system is self-healing from the viewpoints of diagnosis and configuration, with best possible overall channel cost Θ(n). [LaForge et al 1994] explicates the corresponding theorems, as well as conditions for their application. The invention is cognizant of these theorems and conditions, and synthesizes optimum connectivities which take advantage of them.

The invention furthermore encompasses variant (f), a particular application of which we illustrate as a refinement to our GovNet example. The GovNet traffic set specifies the geographic locations that we must connect together. Suppose we desire to map these geographic locations to the nodes of K₁₁(88) previously described. In this case variant (f) is both more constrained and less constrained than problems readily solved by standard VLSI layout algorithms [LaForge 1994 ].

It is more constrained since, unlike the case with microelectronic parts or on-chip cells, we are not at liberty to relocate the buildings that house GovNet's agency clients. The implementation is less constrained in that the distances involved ameliorate the penalty for lines that cross, a penalty which is severe in the world of circuit boards and VLSI [Ullman 1984]. As a first order approximation, and for the sake of illustration, let us estimate dollar cost by the great circle distance between nodes.⁴ We therefore want to map K₁₁(88) into given locations in the United States, in a fashion that minimizes the total great circle distance among the pairs of points corresponding to edges in the graph K₁₁(88). ⁴Of course, the complexities of topography and rights-of-way blur the accuracy of our approximation.

However, the contemporary state-of-the-art is such that, apparently, there is no ready-made algorithm, akin to the minimum spanning tree procedures of Kruskal and Prim [Corman et at 1993], which exactly minimizes the surface distance spanned by a cycle of K-cubes. Leighton's classical divide and conquer approach for VLSI layout out does not apply directly ([Ullman 1984] Sec. 3.5). This in part because we are not at liberty to move the destinations in our network, in part because Hamming graphs are non-planar, and in part we do not have a ready-made analog to the Tarjan-Lipton separator theorem for planar graphs. If we did have such a theorem, however, then we likely would be able to devise accurate, fast algorithms for embedding. Until and after the art attains this level of sophistication, however, the invention remains poised to apply best-of-breed approximation algorithms.

For example, the invention can (and, in this case does) start with all 3828 great circle distances between the physical locations corresponding to K₁₁(88). The invention then applies a greedy heuristic to constructively bound the length of the embedding from above. Greedy heuristics exactly solve the class of problems known as matroids [Corman et at 1993], and, moreover, serve as useful approximations where we lack an algorithm which solves a problem exactly. In the context of set covering, for example, [Chvatal 1979] shows how a greedy heuristic yields a solution that is within a logarithmic factor of optimal. Employing such a heuristic, the invention maps K₁₁(88) to the nodes of the GovNet traffic set, with a total length of 854,000 kilometers. FIG. 2A depicts channels to four cities in this mapping. For a non-trivial lower bound, the invention uses Prim's algorithm to successively generate ƒ+1=12 minimum spanning trees, such that each tree is pairwise edge-disjoint from all others. In this fashion, the invention finds that the least total length for which we could hope would be 595,595 kilometers.

To recap: by applying a simple, greedy heuristic, the invention, here illustrated for a special case of variant (f), delivers an embedding whose aggregate great circle length is within 44% of the minimum. The key point is that the invention remains useful, novel, and fully capable of being deployed, even in the absence of theorems and sub-algorithms which compute exact solutions to variants. Further, the invention is enhanced as the science of connectivity advances. For example, a K-cube analog to the Tarjan-Lipton separator theorem, or a channel dispersal algorithm based on Voronoi partitions of space [Preparata and Shamos 1985], might enable the invention to invoke a superior replacement to the greedy heuristic cited, with attendant improvements in solution optimality or software execution time.

The invention having been described in preferred embodiments for prototypical cases (1) and (3), as well as for variants (a) through (f), and for variant (j), it should be apparent how to achieve analogous behavior for variants (g) through (i), as well as variants (k) through (m). It should also be apparent how the invention is readily adapted to in situ operation of self-healing connectivities, as recounted in the BRIEF SUMMARY herein, and in large part indicated by the wireless applications depicted by FIG. 5. As to the latter, a particularly beneficial application of the invention enables robust communications among mobile devices. For example, the invention would enable telephone calls in areas such as canyons near Los Angeles, or blacked-out regions near the Central Intelligence Agency in Langley, Va. Although centralized antennae are ineffective in such areas, repeater functions, with minimally latent, self-healing quorum connectivity determined by the invention, would enable more reliable communications, at reduced cost.

The invention subsumes the aforementioned cases, and variants thereof, individually or severally, in any combination. In general, the invention solves the following extension of (1) and (3):

Synthesize connectivity among n-nodes, maximizing net quorum value, subject to constraints imposed by (a) through (m) (5)

The invention furthermore encompasses (3) in both primal and dual formulations, as they are known in the science of optimization. It is understood that the invention is capable of further modification, uses and/or adaptations following in general the principle of the invention, and including departures from the present disclosure as come within known or customary practice in the art of connectivity, and as may be applied to the essential features set forth, with specific claims enumerated henceforth.

1. A system for prescribing point-to-point channels among nodes, comprising means for
inputting the total number of nodes;
inputting the total number of nodes;
determining an assignment of fewest channels that guarantees every pair of fault-free nodes is connected by some path in the same quorum;
and outputting the channel assignments.

2. The system as recited in claim 1, with means for minimizing the quorum radius or diameter.

3. The system as recited in claim 1, with means for inputting channel cost; and determining a minimum cost channel assignment.

4. The system as recited in claim 1, with means for inputting latencies for nodes and channels; and determining a minimum cost channel assignment that minimizes the maximum quorum latency.

5. The system as recited in claim 1, with means for inputting capacities for nodes and channels; and determining a minimum cost channel assignment which maximizes quorum throughput.

6. The system as recited in claim 1, with means for inputting node values; and determining a channel assignment with maximum quorum value, gross or net.

7. The system as recited in claim 1 with faults distributed probabilistically or deterministically.

8. The system as recited in claim 1, such that the guarantee of quorum formation is replaced by probabilistic assurance.

9. The system as recited in claim 1, such that faults may occur in channels, nodes, or both channels and nodes.

10. The system as recited in claim 1, such that the channel assignment is required to be regular, or nearly so.

11. The system as recited in claim 1, such that the quorums may contain an arbitrarily specified number or proportion of faults.

12. The system as recited in claim 1, such that the channel assignments correspond to test assignments for mutual test and diagnosis (MTAD).

13. The system as recited in claim 1, such that edges in the underlying graph model are generalized to directed multi-edges or hyper-edges.

14. A computer implementation of the system recited in claim 1.

15. The computer implementation as recited in claim 14, with the objective of designing or operating multicomputers, networks, bus structures, or circuits.

16. A method for prescribing point-to-point channels among nodes, comprising
inputting the total number of nodes;
inputting the total number of nodes;
determining an assignment of fewest channels that guarantees every pair of fault-free nodes is connected by some path in the same quorum;
and outputting the channel assignments.

17. The method as recited in claim 16, additionally minimizing the quorum radius or diameter.

18. The method as recited in claim 16, additionally inputting channel cost; and determining a minimum cost channel assignment.

19. The method as recited in claim 16, additionally inputting latencies for nodes and channels; and determining a minimum cost channel assignment that minimizes the maximum quorum latency.

20. The method as recited in claim 16, additionally inputting capacities for nodes and channels; and determining a minimum cost channel assignment which maximizes quorum throughput.

21. The method as recited in claim 16, additionally inputting node values; and determining a channel assignment with maximum quorum value, gross or net.

22. The method as recited in claim 16, with faults distributed probabilistically or deterministically.

23. The method as recited in claim 16, such that the guarantee of quorum formation is replaced by probabilistic assurance.

24. The method as recited in claim 16, such that faults may occur in channels, nodes, or both channels and nodes.

25. The method as recited in claim 16, such that the channel assignment is required to be regular, or nearly so.

26. The method as recited in claim 16, such that the quorums may contain an arbitrarily specified number or proportion of faults.

27. The method as recited in claim 16, such that the channel assignments correspond to test assignments for mutual test and diagnosis (MTAD).

28. The method as recited in claim 16, such that edges in the underlying graph model are generalized to directed multi-edges or hyper-edges.
